(19) United States
(12) Patent Application Publication
(10) Pub. No.: US 2019/0253456 A1
(43) Pub. Date: Aug. 15, 2019

(54) SYSTEM AND METHOD FOR DETECTION OF AND SECURING AGAINST MULTIFUNCTION PERIPHERALS DEVICE POLICY BREACHES

(71) Applicants: Kabushiki Kaisha Toshiba, Minato-ku (JP); Toshiba TEC Kabushiki Kaisha, Shinagawa-ku (JP)

(72) Inventor: Jianxin WANG, Irvine, CA (US)

(21) Appl. No.: 15/893,093

(22) Filed: Feb. 9, 2018

(51) Int. Cl. H04L 29/06; G06F 21/45

(52) U.S. Cl. CPC H04L 63/20; H04L 67/10; G06F 21/45; H04L 63/083

(57) ABSTRACT

A system and method for multifunction device security includes determining when a device administrator's login credentials may have been compromised by violations of a device security policy. Approved device security settings corresponding to a multifunction peripheral are stored in memory and sent to the multifunction peripheral via the network interface. Current device security settings data are received from the multifunction peripheral via the network interface. The current device settings are tested relative to the approved device security settings. Violations determined from the testing trigger sending of a violation notification data to the multifunction peripheral via the network. Notification is received when violations exceed a threshold level and a reset of device administrator login credentials is commenced.

### TECHNICAL FIELD

This application relates generally to policy-based operation of multifunction peripherals. This application relates more particularly to detection of breaches in policy settings on individual multifunction peripheral devices while securing them against further unauthorized policy changes.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions.

MFPs have evolved from mere document processing devices to devices that include network and direct data communication with other devices such as tablets, smart phones, workstations, servers and other MFPs. MFPs monitor a large number of machine attributes, including paper usage, copy count, toner level, environmental conditions, error conditions and the like. An MFP may be programmed to periodically contact a network server and check for software or firmware updates. An MFP may maintain usernames, passwords and device usage credentials for a large number of users. An MFP may be tasked with periodically generating and reporting usage or error reports. Many other MFP functions may be enabled or customized for any particular MFP.

MFP configuration can be done on each individual device. This can be difficult, particularly when a large number of MFPs are in concurrent service at a company. It would be cost and time prohibitive if a technician had to physically approach and configure many MFPs which may be scattered about many different locations. This can be particularly wasteful when each machine is to be configured in the same or similar ways. More recently, MFP configuration can be done via a network connection. While configurable via a network, MFPs can still be configured locally, such as via their touchscreen interface, by administrative personnel.

It will be seen from the forgoing that MFP device configuration that setting device policies provides a powerful, efficient and effective tool for device administration. However, changing of policies by uninformed users can result in added cost, device damage or compromised data security.

### SUMMARY

In accordance with an example embodiment of the subject application, approved device security settings corresponding to a multifunction peripheral are stored in memory and sent to the multifunction peripheral via the network interface. Current device security settings data are received from the multifunction peripheral via the network interface. The current device settings are tested relative to the approved device security settings. Violations determined from the testing trigger sending of a violation notification data to the multifunction peripheral via the network. Notification is received when violations exceed a threshold level and a reset of device administrator login credentials is commenced.

### BRIEF DESCRIPTION OF THE DRAWINGS

Various embodiments will become better understood with regard to the following description, appended claims and accompanying drawings wherein:

FIG. 1 an example embodiment of a cloud-based MFP device security policy management system;

FIG. 2 is an example embodiment of a document rendering system;

FIG. 3 is a flowchart of an example embodiment of a process for compiling and sending current device security settings to a cloud;

FIG. 4 is a flowchart of an example embodiment of a process to store the device data;

FIG. 5 is a flowchart of an example embodiment of a process to create, edit, and distribute device security policies;

FIG. 6 is a flowchart of an example embodiment of a process to apply and enforce device security policies;

FIG. 7 is a flowchart of an example embodiment of a process to monitor recurrent security policy violations and stop potential security breaches;

FIG. 8 is an example embodiment of a cloud multifunction peripheral security policy management system;

FIG. 9 is a hardware block diagram of an example embodiment of a cloud service comprised of a cloud server 904 and one or more MFPs; and

FIG. 10 is a software block diagram of an example embodiment.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

By way of particular example, Toshiba TEC multifunction peripheral (MFP) devices are configurable via their e-BRIDGE CloudConnect (eCC web) interface. E-BRIDGE CloudConnect is an integrated system of embedded and cloud-based applications that provide functionality to support remote monitoring and management of Toshiba MFPs. It enables management of configuration settings through automated interaction. E-BRIDGE CloudConnect gathers service information from connected MFPs, including meter data, to speed issue diagnosis and resolution.

Device configuration with eCC can be completed by setting device policies. Policies are used to create a near infinite number of attributes to monitor and configure a MFP or fleet of MFPs. Policies are organized into categories, and templates are provided to make the configuration of a policy fairly intuitive. Policy categories for eCC include settings for:
Firmware Update
Device Error Processing
Backup
Device Communication
Custom Settings
Additional policy categories

Data for each MFP is compared to its policy settings. A policy includes a list of parameters (rules) for incoming data as well as functions and actions to perform based on the data. When data falls outside the parameters of the policy rule, it is a policy violation. When a policy violation occurs, an alert is triggered for the MFP. Alerts may commence policy action such as:

a. The violation is displayed on the Devices page on the eCC portal.

b. If the policy was written to trigger actions, the system executes these actions.

Communication sequences can be set, such as to be timed at off-hours, by a policy. By way of example, a policy may further dictate that the following sequence occurs on the first day of every month:
Registration
Check for updates
Download updates (skip if none)
Execute updates (skip if none)
Send updated data set

In the event of alerts, an MFP policy may by way of example initiate communications to a cloud server in near real time. The policy may direct the MFP to send the following:
MFP Identification (security token)
Error Code
Short Description of the Alert
Send updated data set

As noted above, policy-based control of MFPs provides for flexible and powerful device configuration options. MFP devices are currently equipped with an embedded software and user interface that allows an administrator or service technician to configure the device. Using the eCC application, these configurations and further monitoring and control of the system are completed via policies. The policy creation method relies on manual input of settings and rules. There are a variety of policy categories including error codes and device settings. Within each policy category, a policy is created by defining a set of rules or settings. Once applied to a device, the policy settings will be applied and/or an event will be triggered when a specified value or condition is reached.

MFP operation is overseen by an embedded intelligent controller. When operation is controlled by policies, the controller may monitor when policies are changed or when violations to policies occur. A system administrator may have an ability to login to an MFP with their administrative credentials allowing configuration or policy changes that are otherwise locked from device users. Such changes may themselves trigger a violation of device security policies which may be locked from modification from local system administrators. In situations such as when a large number of policy changes are detected, when a series of policy changes are made over a set time period, or when a frequency of policy changes increases, this may provide an indication that the administrator's login credentials, such as their username and password, have been compromised.

The subject application teaches example embodiments wherein an MFP device interacts with a server, suitably via a service cloud, to monitor policy violations and trigger a change in administrator login credentials when a sequence of violations indicates that they may have been compromised. If so, the system suitably notifies the administrator, changes their login credentials and provides them with the new credentials to lock out unauthorized users and prevent further incursion.

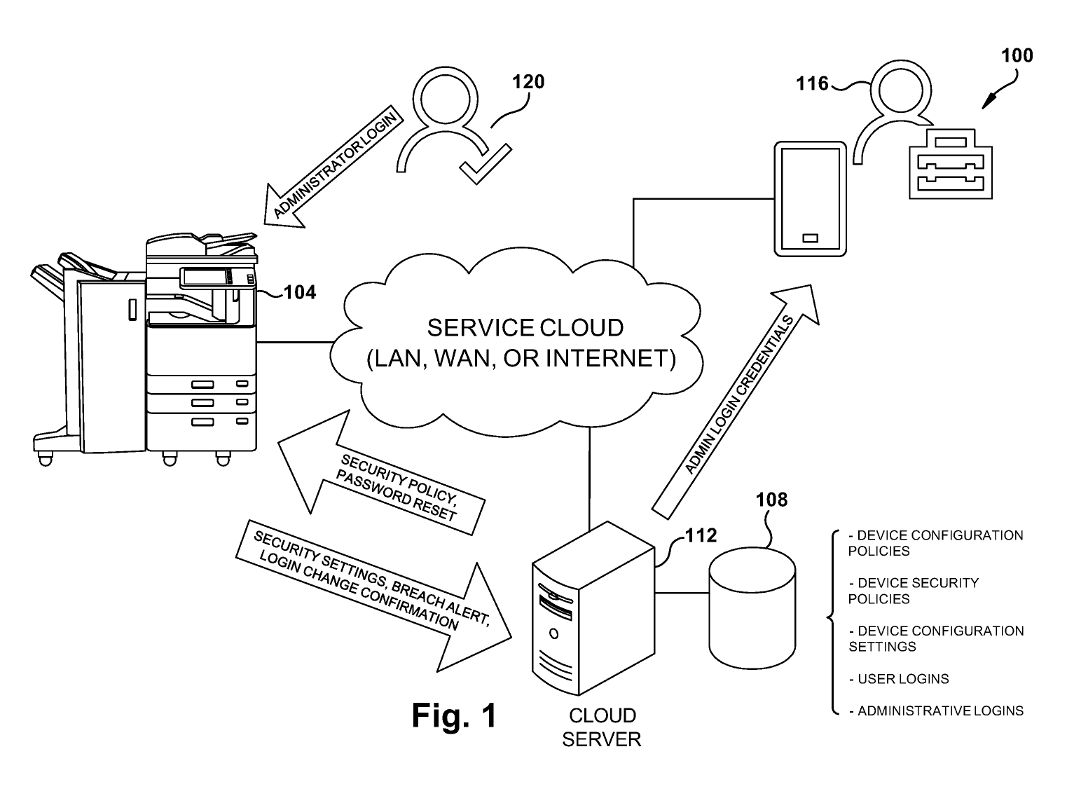

In accordance with the subject application, FIG. 1 illustrates an example embodiment of a cloud-based MFP device security policy management system 100 for one or more MFPs as exemplified by MFP 104. Device data from MFP 104 is available from data storage 108 working with an administrative device suitably comprised of a cloud sever 112 or functionality embedded in an MFP itself. Storage 108 suitably includes data corresponding to device configuration policies, device security policies, device configuration settings, user logins and administrative logins for MFPs such as MFP 104. Administrator 116 is credentialed for administrator login 120 to MFP 104 with device configuration privileges, such as privileges to change device policies or configurations. Cloud server 112 provides a security policy and administrative password reset instructions to MFP 104 as will be detailed below. MFP 104 also provides security settings, breach alerts and login change confirmation to cloud server 112. Administrator 116 is provided with alerts which may include new login information in the event of one or more policy security violations which may be triggered, for example, by too many violations relative to a violation count or a violation frequency.

In the example embodiment of FIG. 1, with the cloud-based MFP device security policy management system 100, policy violations can be corrected immediately once detected. However, detection or correction of policy violations may be spaced apart so that the normal functionalities of the device are not significantly impacted. This leaves a window of opportunities for the above mentioned security vulnerability to be exploited. More specifically, device security settings can be manually altered against the security policy if the system administrator credentials are stolen or compromised. A high frequency of recurrent security policy violations may be a sign of an on-going security policy breach. Accordingly, cloud-based MFP device security policy management system 100 functions to identify a potential device security policy breach by monitoring the frequency of recurrent security policy violations, and then immediately stops the potential security breach by automatically resetting the device's built-in system administrator credentials.

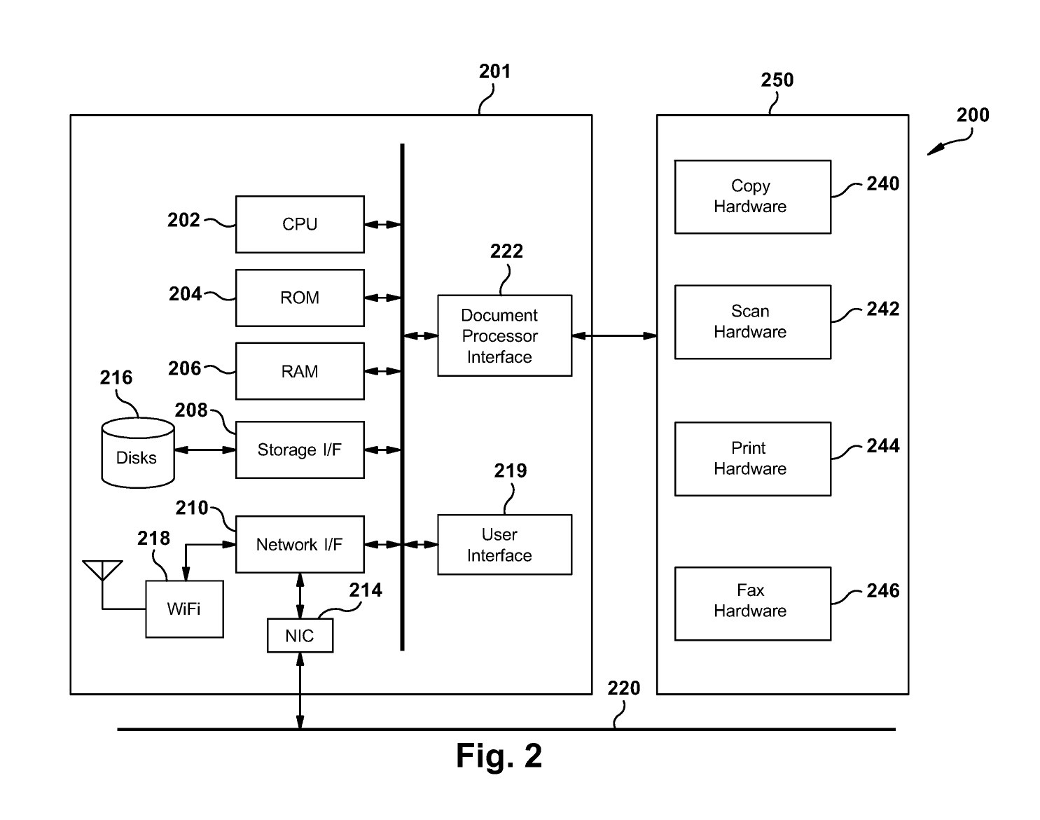

Turning now to FIG. 2 illustrated is an example embodiment of a document rendering system 200 suitably comprised within an MFP, such as with MFP 104 of FIG. 1. Included in controller 201 are one or more processors, such as that illustrated by processor 202. Each processor is suitably associated with non-volatile memory, such as ROM 204, and random access memory (RAM) 206, via a data bus 212.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 220, or to a wireless data connection via wireless network interface 218. Example wireless connections include cellular, Wi-Fi, Bluetooth, NFC, wireless universal serial bus (wireless USB), satellite, and the like. Example wired interfaces include Ethernet, USB, IEEE 1394 (FireWire), Lightning, telephone line, or the like. Processor 202 is also in data communication with one or more sensors which provide data relative to a state of the device or associated surroundings, such as device temperature, ambient temperature, humidity, device movement and the like.

Processor 202 can also be in data communication with any suitable user input/output (I/O) interface 219 which provides data communication with user peripherals, such as displays, keyboards, mice, track balls, touch screens, or the like. Also in data communication with data bus 212 is a document processor interface 222 suitable for data communication with MFP functional units. In the illustrate example, these units include copy hardware 240, scan hardware 242, print hardware 244 and fax hardware 246 which together comprise MFP functional hardware 250. It will be understood that functional units are suitably comprised of intelligent units, including any suitable hardware or software platform.

A hardware monitor suitably provides device event data, working in concert with suitable monitoring systems. By way of further example, monitoring systems may include page counters, sensor output, such as consumable level sensors, temperature sensors, power quality sensors, device error sensors, door open sensors, and the like. Data is suitably stored in one or more device logs, such as in storage 216 of FIG. 2.

Controller 201 is suitably provided with an embedded web server system for device configuration and administration. A suitable web interface is comprised of TOPACCESS Controller (sometimes referred to in the subject illustrations as “TA”), available from Toshiba TEC Corporation.

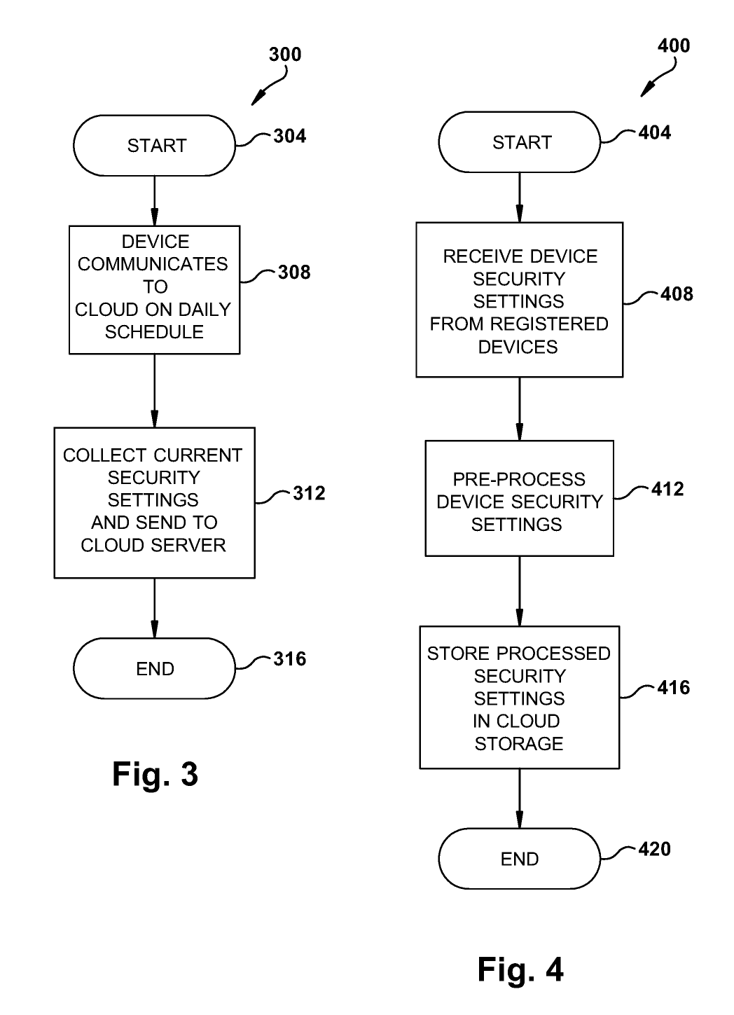

Referring next to FIG. 3, illustrated is a flowchart 300 of an example embodiment for compiling and sending current device security settings to a service cloud such as the cloud-based MFP device security policy management system described above with regard to FIG. 1. The process commences at block 304. Security settings are sent to the service cloud, suitably on a daily schedule, at block 308. Security settings are collected and sent to the service cloud via HTTPS or any other suitable protocol at block 312 after which the process ends at block 316 until the next scheduled event.

FIG. 4 is a flowchart 400 of an example embodiment to process and store the device data. The process commences at block 404 and the service cloud receives the device security settings from the registered devices at block 408. Any suitable protocol can be used, including the Microsoft Windows Communication Foundation (WCF) protocol. WCF Data Services (formerly known as “ADO.NET Data Services”) is a component of the .NET Framework that enables creation of services that use the Open Data Protocol (OData) to expose and consume data over the Web or intranet by using the semantics of representational state transfer (REST). OData exposes addressable data as resources. Data is accessed and changed by using standard HTTP verbs of GET, PUT, POST, and DELETE. OData uses the entity-relationship conventions of the Entity Data Model to expose resources as sets of entities that are related by associations. Device security device security settings are pre-processed at block 412 by a cloud device data manager and stored in cloud storage at block 416. The process ends at block 420.

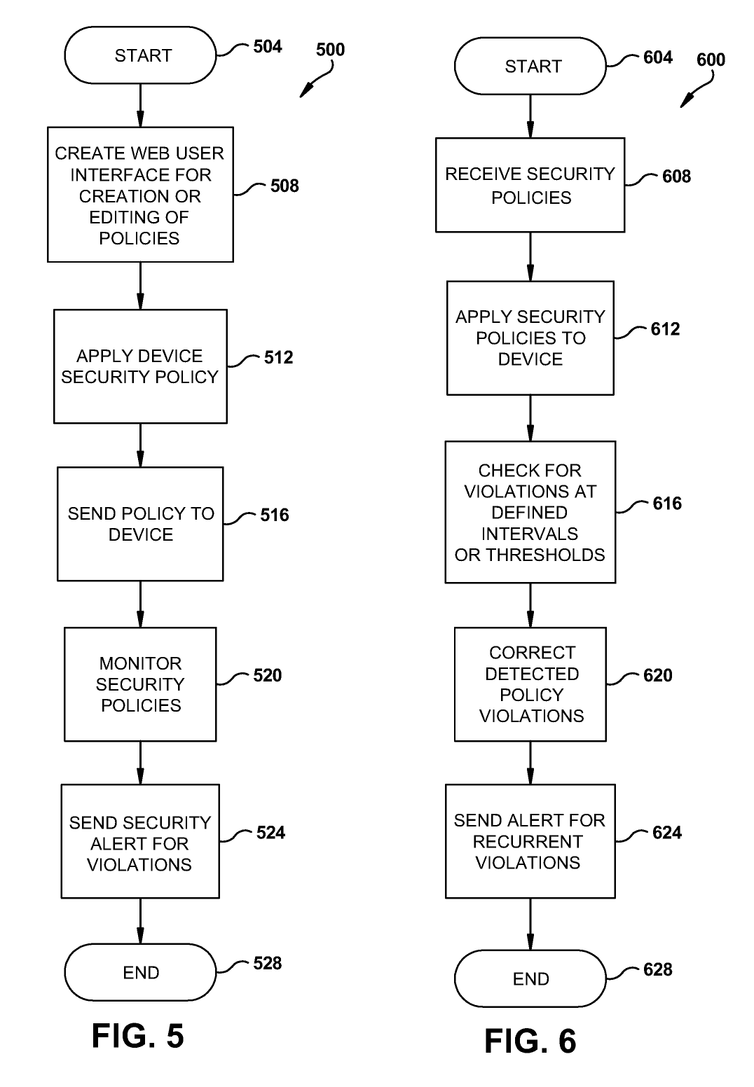

FIG. 5 is a flowchart 500 of example embodiment to create, edit, and distribute security policies. The process commences at block 504. Next, the service cloud provides a web user interface at block 508, such as a website to allow security polies to be created and edited by a registered user. A security policy is applied to a device at block 512 and the policy settings are sent to the device at block 516, suitably via a WFC data service, the next time device communicates to the service cloud. The security policies are constantly monitored by a cloud security policy manager at block 520. Interested parties are notified of any policy violations when they occur at block 524 and the process ends at block 528.

FIG. 6 is a flowchart of an example embodiment 600 of a process to apply and enforce security policies. The process commences at block 604 and security policies are received from the service cloud at block 608. Once received, the security policies are applied to the device by a device security policy manager at block 612. Next, the device security policy manager checks at block 616 for any policy violations at a pre-defined interval in case the security settings are altered in any way. Next, policy violations are corrected immediately once detected at block 620. A security alert is sent to the service cloud at block 624 whenever a recurrent violation has occurred on the device. The process ends at block 628.

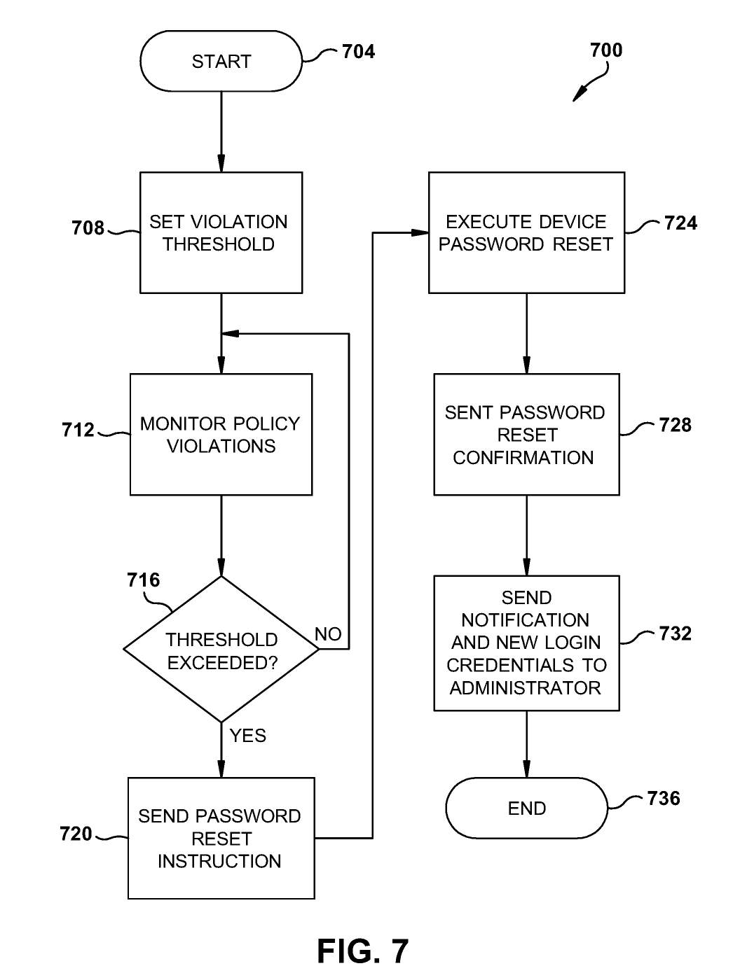

FIG. 7 is a flowchart 700 of an example embodiment of a process to monitor recurrent security policy violations and stop potential security breaches. The process commences at block 704 and a violation threshold is set at block 708. Suitable thresholds include a number of violations, frequency of violations, severity of violations, and the like. Recurrent policy violations are monitored at block 712, suitably continuously, by a cloud security policy manager. Once the frequency of recurrent policy violations has exceeded a pre-defined threshold at block 716, an on demand instruction is sent to the device to reset the password at block 720 for its defined administrator. The device executes the password reset instructions at block 724 once received from the service cloud and a confirmation to the service cloud upon is sent at block 728 on a successful password reset. Once the service cloud has received the password reset confirmation from the device, an alert for a potential security breach is sent together with the new administrator's password to the registered device owner at block 732 and the process ends at block 736.

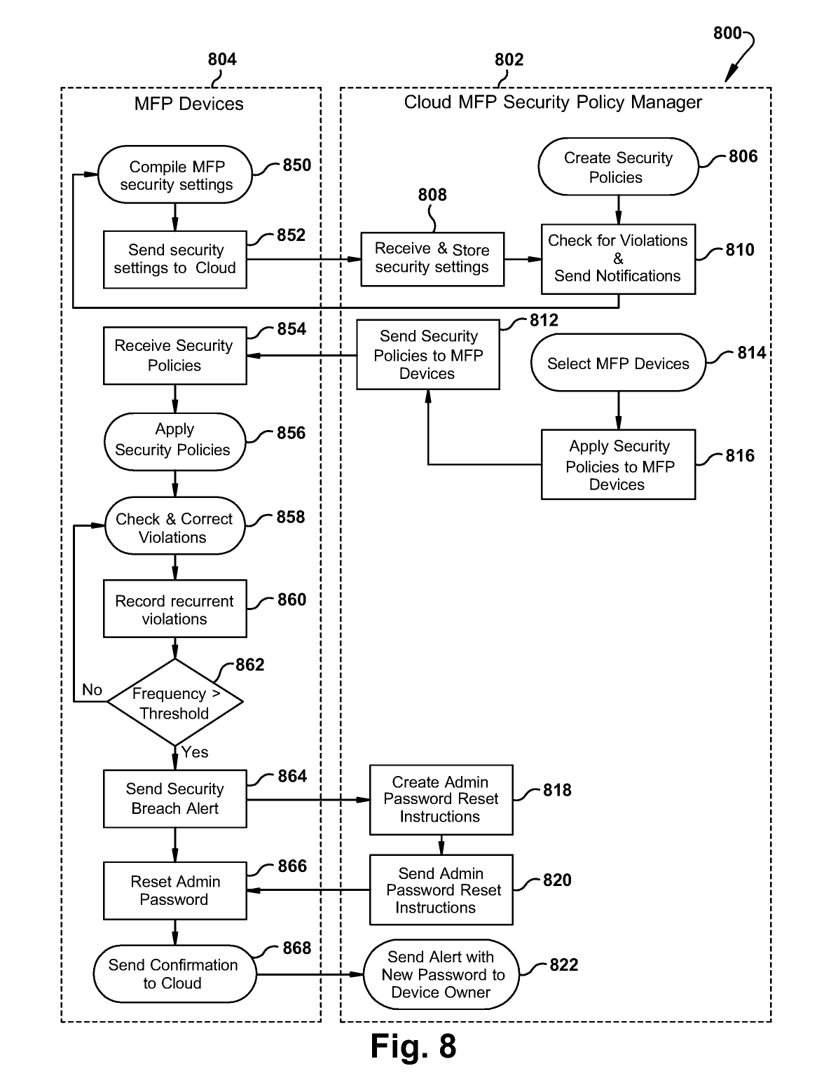

FIG. 8 is an illustration of an example embodiment of a cloud-based MFP device security policy management system 800 that employs a cloud MFP security policy manager 802 and one or more MFPs 804. MFP security policy manager 802 functions to create security policies (806) and receive and store security settings from each MFP (808) to check for violations and send notifications (810). MFP security policy manager 802 also functions to select MFP devices (814), apply security polices to the selected MFP devices (816), and send the security polices to the selected MFP devices (812).

MFP security policy manager 802 further functions to create an administrator password (818) when it receives a security breach alert from an MFP and send an administrator password reset to the MFP (820). MFP security policy manager 802 further sends alerts with a new password or any suitable login change to the device owner or administrator (822)

Each MFP device 804 compiles MFP security settings (850) and sends them to the cloud (852). MFP device 804 receives security polices from the cloud (854) and applies them to the device (856). MFP devices further check and correct violations (858), record violations (860) and test violations against a violation threshold such as violation frequency (862). When a threshold is exceeded, it sends a security breach alert (864) to the cloud. The MFP resets and administrative password (866) upon notification to do so from the cloud, and confirmation of a password reset is sent the cloud (868).

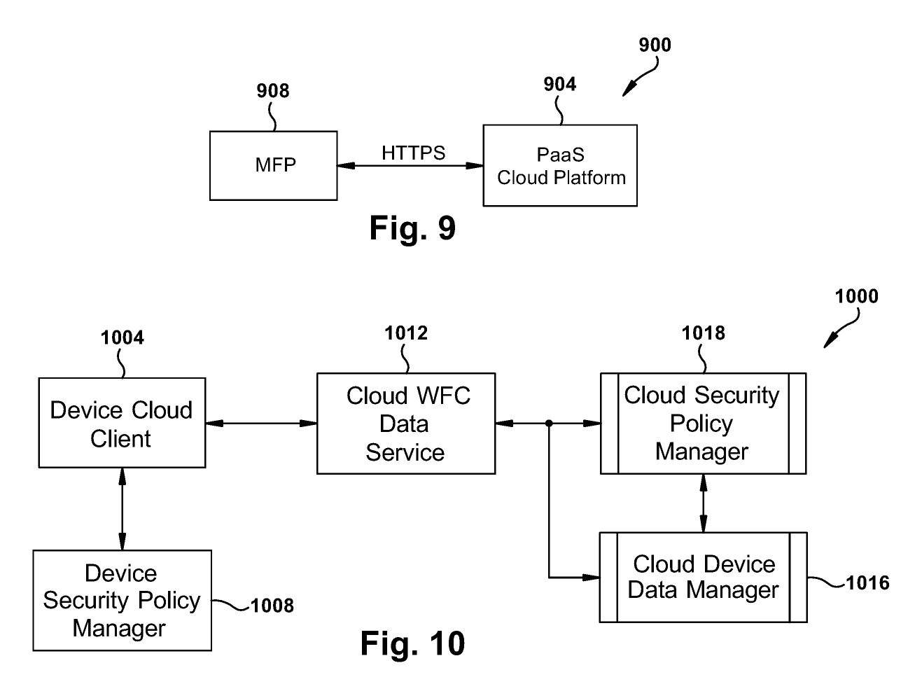

FIG. 9 is an example embodiment of a hardware block diagram 900 showing a cloud service comprised of a cloud server 904 and one or more MFPs 908. Cloud service platform 904 is suitably comprised of a platform-as-a-service (PaaS) architecture.

FIG. 10 is an example embodiment of a software block diagram 1000.

Included is a device cloud client 1004 that compiles device security settings and sends them to the cloud. Device security policy manager 1008 receives a security policy from the cloud and applies and enforces the security policy on an MFP. Device security policy manager 1008 also executes other on demand instructions received from the cloud. Cloud data service 1012 allows the cloud to receive security settings from the device and to send security policies and other instructions to the device. Cloud device data manager 1016 processes and store the data received from the device. Cloud security policy manager 1018 manages security policies to be created, modified, and monitored. Cloud security policy manager 1018 also allows policy violation notifications to be sent to the interested parties.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system comprising:
a network interface; and
a processor and associated memory,
the memory configured to store approved device security settings data corresponding to a multifunction peripheral,
the processor configured to send the approved device security settings data to the multifunction peripheral via the network interface,
the processor further configured to receive current device security settings data from the multifunction peripheral via the network interface,
the processor further configured to test received current device security settings data relative to approved device security settings data,
the processor further configured to send violation notification data to the multifunction peripheral via the network interface when a violation of security settings is determined by the test,
the processor further configured receive threshold violation data indicative of recurrent violations in excess of a level prescribed by violation frequency threshold data, and
the processor further configured to commence a reset of device administrator login credentials responsive to received threshold violation data.

2. The system of claim 1 wherein the processor is further configured to send the violation frequency threshold data to the multifunction peripheral.

3. The system of claim 1 wherein the processor is further configured to generate updated administrator login credentials prior to commencing the reset of device administrator login credentials.

4. The system of claim 1 wherein the processor is further configured to receive a confirmation from the multifunction peripheral that the device administrator login credentials have been reset.

5. The system of claim 4 wherein the processor is further configured to send an alert to an administrator of the multifunction peripheral in accordance with a reset of device administrator login credentials.

6. The system of claim 5 wherein the alert includes new login credentials generated by the processor.

7. The system of claim 1 wherein the processor is further configured to generate updated device security settings data for the multifunction peripheral.

8. A method comprising:
storing approved device security settings data corresponding to an multifunction peripheral in a memory;
sending the approved device security settings data to the multifunction peripheral via a network interface;
receiving current device security settings data from the multifunction peripheral via the network interface;
testing, with a processor, received current device security settings data relative to approved device security settings data;
sending violation notification data to the multifunction peripheral via the network interface when a violation of security settings is determined by the test;
receiving threshold violation data indicative of recurrent violations in excess of a level prescribed by violation frequency threshold data; and
resetting device administrator login credentials responsive to received threshold violation data.

9. The method of claim 8 further comprising sending the violation frequency threshold data to the multifunction peripheral.

10. The method of claim 8 further comprising generating updated administrator login credentials prior to resetting device administrator login credentials.

11. The method of claim 10 further comprising sending updated administrator login credentials generated by the processor.

12. The method of claim 8 further comprising receiving a confirmation from the multifunction peripheral that the device administrator login credentials have been reset.

13. The method of claim 12 further comprising sending an alert to an administrator of the multifunction peripheral in accordance with a reset of device administrator login credentials.

14. The method of claim 8 further comprising generating updated device security settings data for the multifunction peripheral.

15. A multifunction peripheral comprising:
a network interface;
an intelligent controller including processor and associated memory,
the intelligent controller configured to receive security policy settings from an associated server via the network interface, and
the intelligent controller operable in accordance with received security policy settings;
a document processing engine operable in accordance with instructions issued from the controller; and
an interface configured to receive an administrator login from an administrator of the multifunction peripheral,
wherein the controller includes an administrative command mode operable for configuration of the multifunction peripheral operable in accordance with an acceptable administrator login,
wherein the controller is further configured to receive threshold data representative of a selected violation level,
wherein the controller is further configured to monitor violations of the received security policy,
wherein the controller is further configured to generate a notification to the server when monitored violations exceed the selected violation level, and
wherein controller is further configured to reset the administrator login in accordance with a response to the notification by the server.

16. The multifunction peripheral of claim 15 wherein the administrator login is comprised of a username and password.

17. The multifunction peripheral of claim 15 wherein the threshold data is corresponds to an acceptable violation rate and wherein the controller is further configured to monitor a time sequence of violations.

18. The multifunction peripheral of claim 15 wherein the controller is further configured to send a confirmation to the server corresponding to a reset of the administrator login.

19. The multifunction peripheral of claim 15 wherein the controller is further configured to generate a report regarding monitored violations.

20. The multifunction peripheral of claim 19 wherein the controller is further configured to send the report to the administrator contemporaneously with the notification.
